(19) United States
(12) Patent Application Publication
(10) Pub. No.: US 2013/0219276 A1
(43) Pub. Date: Aug. 22, 2013

(54) Method and Device for Playing Video

(71) Applicant: Wenbin Shan, Shenzhen (CN)

(72) Inventor: Wenbin Shan, Shenzhen (CN)

(73) Assignee: TENCENT TECHNOLOGY (SHENZHEN COMPANY) LIMITED, Shenzhen (CN)

(21) Appl. No.: 13/880,776

(22) PCT Filed: Dec. 21, 2011
(86) PCT No.: PCT/CN2011/084385

§ 371 Date: Apr. 22, 2013

(30) Foreign Application Priority Data
Feb. 24, 2011 (CN) 201110044626.9

(51) Int. Cl. G06F 3/0484

(52) U.S. Cl. CPC G06F 3/0484
USPC 715/722

(57) ABSTRACT

Embodiments of the invention provide a method for playing video and an Instant Messaging (IM) client. The method includes: after receiving a video link, displaying, by the IM client, the video link, summary information of a corresponding video and a local playing operation portal via a client window; after receiving a playing request from a user through the local playing operation portal, creating, by the client, a video playing window, obtaining the corresponding video according to the video link, and playing the obtained video via the created video playing window. By adopting the technical solution provided by embodiments of the invention, the obtained video may be played via the created video playing window. Subsequently, a user may be enabled to play the video simultaneously when employing an IM client. The integration of video playing and IM client may be implemented. And user experience may be improved.

The application claims priority to a Chinese Patent Application 201110044626.9, titled “Method and Device for Playing Video”, which was filed on Feb. 24, 2011. The disclosures of the application No. 201110044626.9 are incorporated here by reference.

### FIELD OF THE INVENTION

The present invention relates to computer technologies, and more particularly, to a method and device for playing video.

### BACKGROUND OF THE INVENTION

With the development of computer technologies and Internet technologies, a link about information, such as news, commodity website and video, can be transmitted via a client window of an Instant Messaging (IM) system to share information. For example, after receiving a news link, an IM client displays the news link via a client window. The IM client may also display title, picture and summary of the news under the link. When receiving a commodity link, an IM client may also display the commodity link via a client window, and display commodity related pictures under the commodity link. If a receiver is interested in a link transmitted by a transmitter, the receiver can click on the link to see specific contents.

In above manner of sharing information, when a receiver plays video, the video may not be displayed directly via a client window of an IM system. Instead, the receiver needs to jump to a webpage to watch the video. Subsequently, client integration may not be achieved.

### SUMMARY OF THE INVENTION

Objectives of the present invention are to provide a method and device for playing video, so as to implement integration of video playing and an Instant Messaging (IM) client. Thus, embodiments of the present invention adopt the following technical solutions.

A method for playing video, which is applied to an IM system, including:

after receiving a video link, displaying, by an IM client, the video link, summary information of a corresponding video and a local playing operation portal via a client window;

after receiving a playing request from a user through the local playing operation portal, creating, by the client, a video playing window, obtaining the corresponding video according to the video link, and playing the obtained video via the created video playing window.

A client of an IM system, including a displaying module, a creating module, an obtaining module and a playing module, wherein

the displaying module is to display a video link, summary information of a corresponding video and a local playing operation portal via a client window, after receiving the video link;

the creating module is to create a video playing window, after receiving a playing request from a user through the local playing operation portal;

the obtaining module is to obtain the corresponding video according to the video link; and

the playing module is to play the video obtained by the obtaining module via the video playing window, which is created by the creating module.

In above embodiments of the present invention, after receiving a video link, an IM client may display the video link and summary information of a corresponding video via a client window. After receiving a playing request from a user, an IM client may create a video playing window, obtain a corresponding video, and play the obtained video via the created video playing window. Subsequently, the user may be enabled to play the video simultaneously when using the IM client. Thus, the integration of video playing and IM client may be implemented. And user experience may also be improved.

### BRIEF DESCRIPTIONS OF DRAWINGS

FIG. 1 is a flowchart illustrating a method for playing video in accordance with an embodiment of the present invention.

FIG. 2 is a flowchart illustrating a method for playing video in accordance with an embodiment of the present invention.

FIG. 3 is a schematic diagram illustrating contents displayed via a client window, in accordance with an embodiment of the present invention.

FIG. 4 is a schematic diagram illustrating how to play video via a video playing window, in accordance with an embodiment of the present invention.

FIG. 5 is a schematic diagram illustrating structure of an Instant Messaging (IM) client, in accordance with an embodiment of the present invention.

### EMBODIMENTS OF THE INVENTION

An embodiment of the present invention provides a method for playing video, which may be applied to an Instant Messaging (IM) system. Detailed descriptions about embodiments of the present invention are provided in the following, accompanying with attached figures.

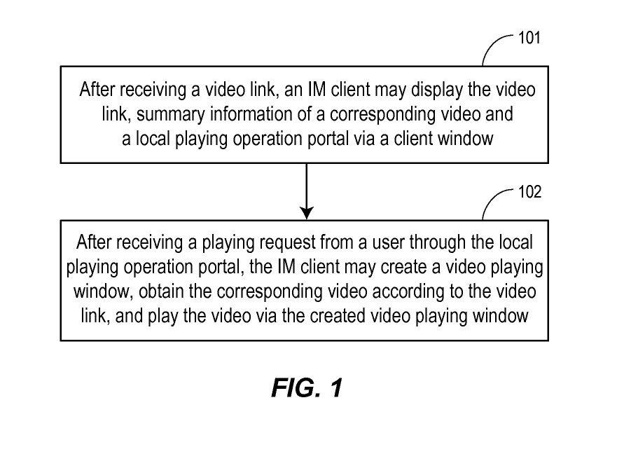

FIG. 1 is a flowchart illustrating a method for playing video in accordance with an embodiment of the present invention. As shown in FIG. 1, the method may include the following blocks.

Block 101, after receiving a video link, an IM client may display the video link, summary information of a corresponding video and a local playing operation portal via a client window.

An IM client may receive a video link transmitted online or offline by a contact. The IM client may also receive a video link promotionally sent by a system or a Service Provider (SP), or a video link transmitted by a third party system.

Block 102, after receiving a playing request from a user via the local playing operation portal, the IM client may create a video playing window, obtain the corresponding video according to the video link, and display the obtained video via the created video playing window.

In the embodiment of the present invention, after receiving the playing request of the user, the IM client may create the video playing window, obtain the corresponding video and display the obtained video via the created video playing window. Thus, the user may be enabled to play the video simultaneously when using the IM client. Subsequently, integration of video playing and IM client may be implemented. And user experience may also be improved.

To describe an embodiment of the invention clearer, descriptions are provided in the following accompanying with a specific example.

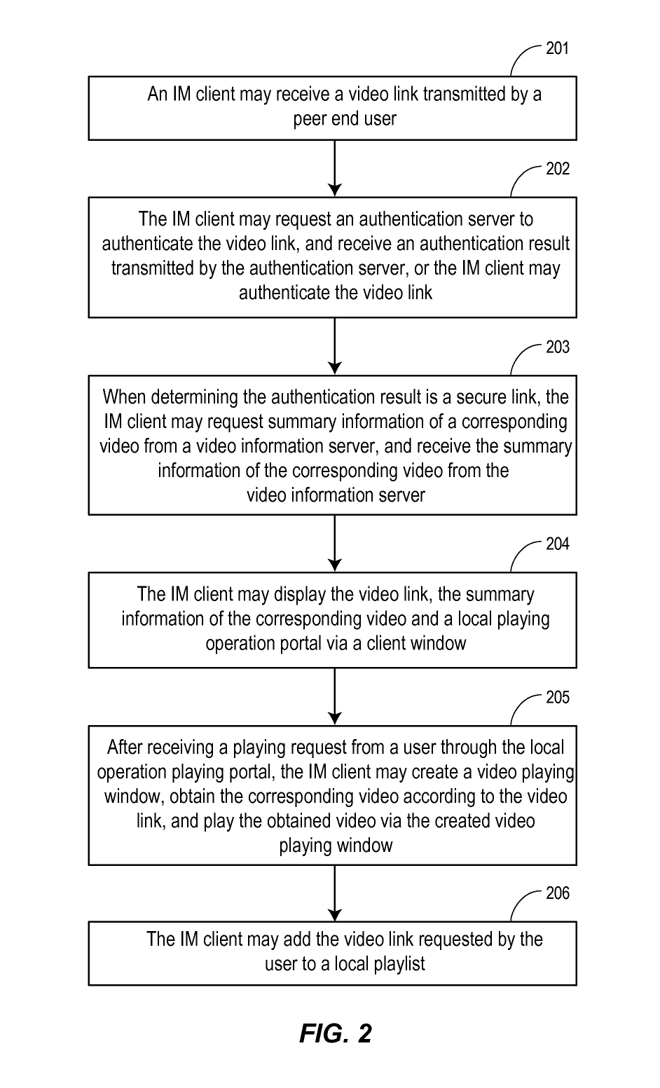

An embodiment of the present invention provides a method for playing video. As shown in FIG. 2, the method includes the following blocks.

Block 201: an IM client receives a video link.

The IM client may receive a video link transmitted online or offline by a contact. The IM client may also receive a video link promotionally sent by a system or a SP, or a video link transmitted by a third party system.

Block 202, the IM client requests an authentication server to authenticate the video link, and receives an authentication result transmitted by the authentication server. Alternatively, the IM client may authenticate the video link. This block is optional.

Specifically speaking, the authentication about the video link includes security authentication. The authentication about the video link may be implemented locally, or in a server. If the function of an application of the client is only available for a video link provided by a specific video provider, the authentication about the video link may be implemented locally by an IM client. For example, if a client only displays a video link of a specific website, the video link may be authenticated by the local client, instead of being authenticated by a server.

The authentication implemented by server side may improve authentication flexibility, simplify functions of client and reduce binding functions of the client. Besides, extension may be easy for the server implemented authentication.

Block 203, when the authentication result is a secure link, the client requests summary information of a corresponding video from a video information server, and receives the summary information of the video responded by the video information server.

The summary information of the video may include video title, brief descriptions of the video, video thumbnail, playing duration of the video, and so on. According to contents provided by the video information server, or settings of the client, the summary information may include at least one of video title, brief descriptions of the title, title thumbnail and playing duration of the title. The summary information may also include other information provided by the system.

Block 204, the client may display the video link, the summary information of a corresponding video and a local playing operation portal via a client window.

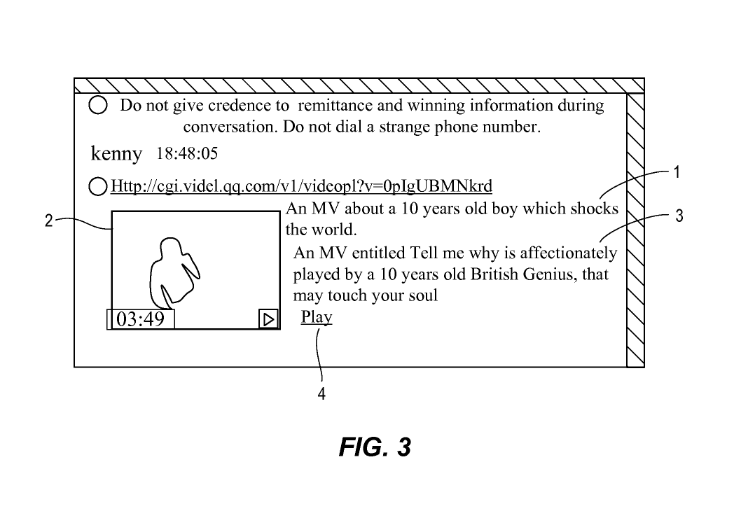

After obtaining the summary information from the video information server, the client may display the obtained summary information via the client window. The local playing operation portal may be provided by the client window. The local playing operation portal may be set as a play button in a video thumbnail, or another button which may activate playing. A user may click on the local playing operation portal provided by the client to play locally, or click on the video link to open an original Uniform Resource Locator (URL), so as to view the video. FIG. 3 is a schematic diagram illustrating how to display contents via a client window, in accordance with an embodiment of the present invention. In the schematic diagram illustrating how to display contents via the client window, video link 1, video thumbnail 2, video summary information 3 and local playing operation portal 4 may be included.

Block 205, after receiving a playing request from a user through the local playing operation portal, the client may create a video playing window, obtain a corresponding video according to the video link and display the obtained video via the created video playing window.

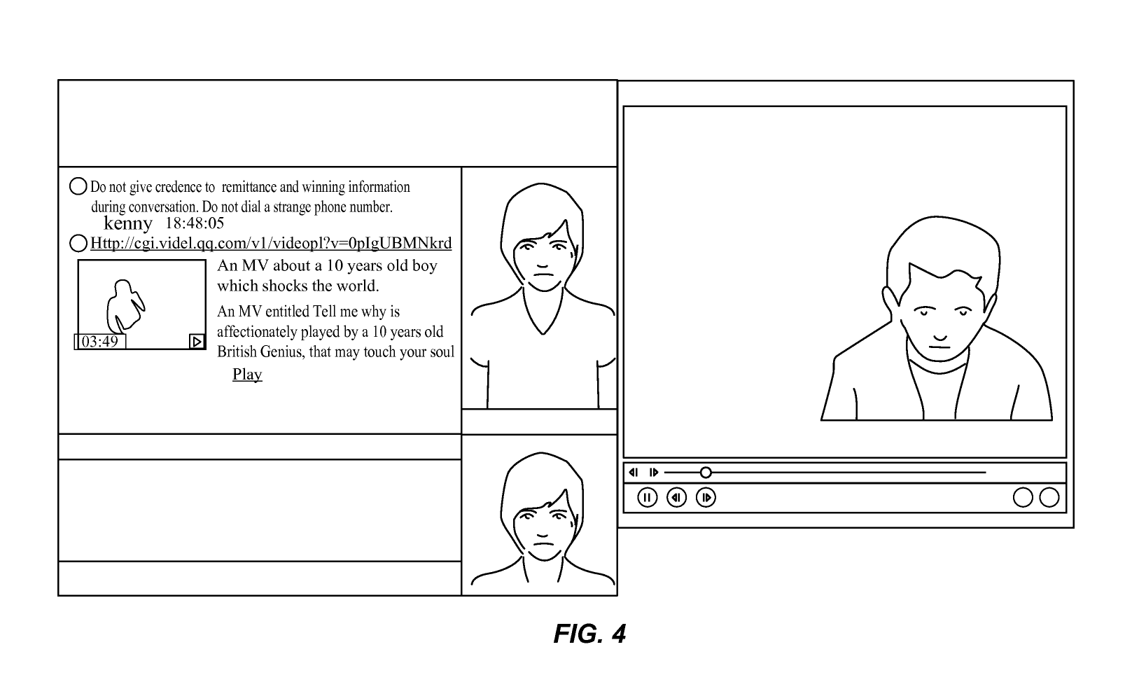

After receiving the playing request from the user, the client may create a playing window at one side of the client window. The playing window may provide functions of scaling, moving and closing. The client may obtain video contents, and play the video via the created video playing window. FIG. 4 is a schematic diagram illustrating how to play a video via a video playing window, in accordance with an embodiment of the present invention.

The client may display the video by installing a plug-in. The client may analyze a video format file of flv included in the video link according to the video link, and download the video format file while displaying the downloaded video via the video playing window. The client may also display the video with an embedded webpage. For example, the client may call codes of a playing module of a website providing the video, via the received video link. And then, the client may embed the called codes into code, which may be employed to implement local playing, so as to play the video via the video playing window of the client.

The user may adjust size and location of the playing window, according to the functions of scaling, moving and closing provided by the playing window. The user may also close the playing window at any time. The user may play the video simultaneously when employing an IM client, by setting a local playing window. Flexibility for playing video may be further improved by using adjustment functions of the window, and user experience may also be improved.

The playing window may include functions of video on top, playing, pausing, volume adjusting, video playing progress adjusting, time displaying and full-screen displaying.

A default playing option may be set in the client. When receiving a video link by a client, a window may be popped up automatically, and the video may be played automatically, by setting the default playing option. Alternatively, when receiving a video link by a client, only summary information may be displayed. And the video may be displayed subsequently, only when the user requests to play locally.

Furthermore, the above process may also include the following blocks.

Block 206, the client adds the video link requested by the user to a local playlist.

The client provides the local playlist, so as to save video links requested by users. View function may be provided by the local playlist. Playing function may be started by a video link in the local playlist. A video, which is played currently, may be switched by the local playlist.

The following problems may be avoided, by setting the local playlist. That is, when a video link is only displayed via a client window, it is difficult to search out the video information, accompanying with refreshing of IM message records of the client window. Subsequently, a user may be facilitated to view and play a video shared in an IM process. Thus, user experience may also be improved.

In the embodiment of the present invention, after receiving the playing request from the user, the IM client may create the video playing window, obtain the corresponding video, and play the obtained video via the created video playing window. Subsequently, the user may be enabled to play the video, while using the IM client. The integration of video playing and IM client may be implemented. And the user experience may be improved. The following problem may be avoided, by setting the local playlist. That is, it is difficult to search out video information, accompanying with refreshing of IM message records of the client window. Subsequently, a user may be facilitated to view and play a video shared in an IM process.

Based on a technical concept same as that of above method embodiment, an embodiment of the present invention also provides an IM client, which may be implemented with software.

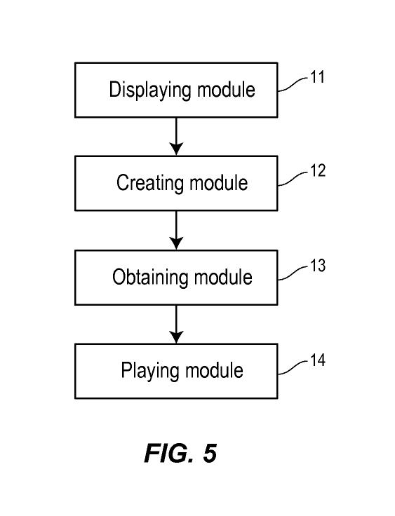

FIG. 5 is a schematic diagram illustrating structure of an IM client, in accordance with an embodiment of the present invention. The IM client in FIG. 5 includes a displaying module 11, a creating module 12, an obtaining module 13 and a playing module 14.

The displaying module 11 is configured to display a video link, summary information of a corresponding video, and a local playing operation portal via a client window, after receiving the video link.

The creating module 12 is configured to create a video playing window, after receiving a playing request from a user through the local playing operation portal.

The obtaining module 13 is configured to obtain a corresponding video according to the video link.

The playing module 14 is configured to play the video obtained by the obtaining module via the video playing window created by the creating module 12.

The IM client may also include an authenticating module.

Before obtaining the video, the authenticating module is configured to request an authentication server to authenticate the video link, after receiving the video link, and receive an authentication result sent by the authentication server.

Before obtaining the summary information of the video, the authenticating module is configured to authenticate the video link after receiving the video link.

The obtaining module is also configured to request summary information of the corresponding video from a video information server, when the authentication result is a secure link, and receive the summary information of the video sent by the video information server.

The IM client may also include a playlist processing module, which is configured to add the video link requested by the user to a local playlist, after receiving the playing request from the user.

Functions of scaling, moving and closing may be provided by the video playing window created by the creating module.

The video playing window created by the creating module may provide at least one of the following functions: video on top, playing, pausing, volume adjusting, video playing progress adjusting, time displaying and full-screen displaying.

The summary information of the video displayed by the displaying module may include at least one of: video title, brief descriptions of the video, video thumbnail, playing duration of the video.

In the embodiment of the present invention, after receiving the playing request from the user, the above IM client may create the video playing window, obtain the corresponding video, and play the obtained video via the created video playing window. Subsequently, the user may be enabled to play the video simultaneously when employing the IM client. The integration of video playing and IM client may be implemented. And user experience may also be improved. The following problem may be avoided, by setting the local playlist. That is, it is difficult to search out the video information, accompanying with refreshing of IM message records of the client window. Subsequently, the user may be facilitated to view and play a video shared in an IM process.

Persons having ordinary skill in the art may easily learn that, a module in a device provided by an embodiment of the invention may be distributed in the device of the embodiment, according to descriptions of the embodiment. Alternatively, a module in a device provided by an embodiment of the invention may change correspondingly, which may be located in one or more devices different from descriptions of the embodiment. Modules in above embodiment may be combined into one module, or may be further divided into at least two sub-modules.

Based on descriptions about above embodiments, persons having ordinary skill in the art may easily learn that, the technical solution of the present invention may be implemented by using software and necessary common hardware platform, which may be better implementation modes in many cases. Definitely, the technical solution of the present invention may also be implemented with hardware. Essentially speaking and compared with the prior art, distinguishing features of technical solution of the invention may be demonstrated with software product, based on above understanding. The computer software product may be stored into a storage medium, which may include several instructions to enable a terminal (which may be a mobile phone, a personal computer (PC), a server or a network device, and so on) to execute method described by each embodiment of the invention.

The foregoing is only preferred implementation modes of the present invention. It should be noted that, for persons having ordinary skill in the art, any improvements and modifications made without departing from principles of the invention, should be covered by protection scope of the invention.

1. A method for playing video, which is applied to an Instant Messaging (IM) system, comprising:
after receiving a video link, displaying, by a client of the IM system, the video link, summary information of a corresponding video and a local playing operation portal via a client window;
after receiving a playing request from a user through the local playing operation portal, creating, by the client, a video playing window, obtaining a corresponding video according to the video link, and playing the obtained video via the created video playing window.

2. The method according to claim 1, further comprising:
after receiving the video link, requesting, by the client, an authentication server to authenticate the video link, and receiving an authentication result transmitted by the authentication server before obtaining the video;
after receiving the video link and when the authentication result demonstrates that the video link is a secure link, requesting, by the client, the summary information of the corresponding video from a video information server, and receiving the summary information of the video transmitted by the video information server before obtaining the video.

3. The method according to claim 1, further comprising:
after receiving the playing request from the user through the local playing operation portal, adding, by the client, the video link requested by the user to a local playlist.

4. The method according to claim 1, further comprising:
providing, by the created video playing window, functions of scaling, moving and closing.

5. The method according to claim 1, further comprising:
providing, by the created video playing window, at least one of: video on top, playing, pausing, volume adjusting, video playing progress adjusting, time displaying and full-screen displaying.

6. The method according to claim 1, wherein the summary information of the video comprises at least one of: video title, brief descriptions of the video, video thumbnail and playing duration of the video.

7. A client of an Instant Messaging (IM) system, comprising a displaying module, a creating module, an obtaining module and a playing module, wherein
the displaying module is to display a video link, summary information of a corresponding video and a local playing operation portal via a client window, after receiving the video link;
the creating module is to create a video playing window, after receiving a playing request from a user through the local playing operation portal;
the obtaining module is to obtain the corresponding video according to the video link; and
the playing module is to play the video obtained by the obtaining module via the video playing window, which is created by the creating module.

8. The client according to claim 7, further comprising an authentication module, wherein
after receiving the video link, the authentication module is to request an authentication server to authenticate the video link, receive an authentication result transmitted by the authentication server, before obtaining the summary information of the video; or
after receiving the video link, the authentication module is to authenticate the video link before obtaining the summary information of the video; and
the obtaining module is further to request the summary information of the corresponding video from a video information server, when the authentication result is a secure link, and receive the summary information of the video transmitted by the video information server.

9. The client according to claim 7, further comprising a playlist processing module, which is to add the video link requested by the user to a local playlist, after receiving the playing request from the user through the local operation playing portal.

10. The client according to claim 7, wherein the video playing window created by the creating module provides functions of scaling, moving and closing.

11. The client according to claim 7, wherein the video playing window created by the creating module provides at least one of: video on top, playing, pausing, volume adjusting, video playing progress adjusting, time displaying and full-screen displaying.

12. The client according to claim 7, wherein the summary information of the video displayed by the displaying module comprises at least one of: video title, brief descriptions of the video, video thumbnail and playing duration of the video.

7. The method according to claim 2, further comprising:
providing, by the created video playing window, functions of scaling, moving and closing.

8. The method according to claim 2, further comprising:
providing, by the created video playing window, at least one of: video on top, playing, pausing, volume adjusting, video playing progress adjusting, time displaying and full-screen displaying.

9. The method according to claim 2, wherein the summary information of the video comprises at least one of: video title, brief descriptions of the video, video thumbnail and playing duration of the video.

16. The client according to claim 11, wherein the video playing window created by the creating module provides functions of scaling, moving and closing.

17. The client according to claim 11, wherein the video playing window created by the creating module provides at least one of: video on top, playing, pausing, volume adjusting, video playing progress adjusting, time displaying and full-screen displaying.

18. The client according to claim 11, wherein the summary information of the video displayed by the displaying module comprises at least one of: video title, brief descriptions of the video, video thumbnail and playing duration of the video.

19. The client according to claim 12, wherein the video playing window created by the creating module provides functions of scaling, moving and closing.

20. The client according to claim 12, wherein the video playing window created by the creating module provides at least one of: video on top, playing, pausing, volume adjusting, video playing progress adjusting, time displaying and full-screen displaying.
